(19) United States
(12) Patent Application Publication
(10) Pub. No.: US 2020/0271184 A1
(43) Pub. Date: Aug. 27, 2020

(54) Vibration Reduction Sheet and Method of Reducing Vibration

(71) Applicant: Avery Dennison Corporation, Glendale, CA (US)

(72) Inventor: Navaneeth Raj BASHYAM, Solon, OH (US)

(21) Appl. No.: 16/758,421

(22) PCT Filed: Nov. 13, 2018
(86) PCT No.: PCT/US2018/060692

§ 371 Date: Apr. 23, 2020

Related U.S. Application Data
(60) Provisional application No. 62/585,144, filed on Nov. 13, 2017.

(51) Int. Cl. F16F 7/108; B60R 13/08; B32B 15/04

(52) U.S. Cl. CPC F16F 7/108; B60R 13/08; B32B 15/04; F16F 2224/02; F16F 2224/0208; F16F 2222/08; B32B 2307/56; F16F 2224/0241; F16F 2224/0225; F16F 2224/025; B32B 2605/00; B32B 2556/00; F16F 2226/042

(57) ABSTRACT

Provided herein is a vibration reducing sheet comprising a damping patch, a stiffening patch, and a substrate. The substrate is connected to the damping patch and the stiffening patch, and in some embodiments, the damping patch and the stiffening patch do not contact one another. The sheet can be connected to a base structure that is prone to vibrations. Because the damping patch and the stiffening patch can thus be applied to different locations of the base structure, the two patch types can independently be positioned to provide enhanced vibration reduction and mitigation.

### FIELD OF THE INVENTION

The present invention relates generally to vibration reduction sheets useful for reducing the vibrational frequencies and/or amplitudes of base structures to which the sheets are applied.

### BACKGROUND OF THE INVENTION

There is a need in many markets, e.g., the automotive market, the home appliance market, and the electronics market, for the reduction of undesired vibrations and associated noise generation. As an example, the automotive industry is trending towards an increased adoption of lighter weight vehicles. As such, there has been an increased use of lighter weight aluminum and polymer materials. The use of these designs and materials, however, has increased issues relating to vehicle vibration and vibration-related noise.

Generally, the noise and vibration issues have been managed through two approaches: the stiffening of the structure geometry to be more resistant to vibration, and the damping of the structure to reduce the vibration amplitude. Along with these solutions, acoustic technologies can be used to absorb, reflect, and isolate sound waves from their source, for example before they reach a passenger in an automotive cabin.

Even in view of these references, the need exists for improved materials and methods applying both damping and stiffening elements for further reducing unwanted vibrations.

### SUMMARY OF THE INVENTION

In one embodiment, the invention is to a vibration reduction sheet. The vibration reduction sheet comprises a damping patch and a stiffening patch, each in contact with a substrate such that the damping patch and the stiffening patch are not in contact with one another. Preferably, the damping patch comprises one or more of an adhesive, a thermoplastic polyurethane, foam, metal, composite, or a rubber. In some embodiments, the metal for the damping patch may be a soft metal, which are metals that have a Mohs scale of mineral hardness of about 4.0 or less. Preferably, the stiffening patch comprises a metal, a carbon fiber reinforced plastic, a glass fiber reinforced plastic, or a combination thereof The metal for the stiffening patch may be a soft metal or a hard metal. Soft metals have a Mohs scale of mineral hardness of about 4.0 or less and harder metals have a Mohs scale of mineral hardness greater than 4.0. In some embodiments, the damping patch comprises one or more layers of a damping material, and one or more layers of a stiffening material, wherein a majority of the thickness of the damping patch consists of the one or more layers of the damping material. In some embodiments, the stiffening patch comprises one or more layers of a stiffening material, and one or more layers of a damping material, wherein a majority of the thickness of the stiffening patch consists of the one or more layers of the stiffening material. Preferably, the ratio of the stiffening patch Young's modulus to the damping patch Young's modulus is greater than or equal to 2. More preferably, the ratio of the stiffening patch Young's modulus to the damping patch Young's modulus is greater than or equal to 10. Yet more preferably, the ratio of the stiffening patch Young's modulus to the damping patch Young's modulus is greater than or equal to 100. Even more preferably, the ratio of the stiffening patch Young's modulus to the damping patch Young's modulus is greater than or equal to 10,000. The vibration reduction sheet can preferably further comprise an adhesive layer connected to the substrate, and a liner layer connected to the adhesive layer. In some embodiments, the damping patch substantially surrounds the stiffening patch. In some embodiments, the damping patch comprises a first damping patch, and the vibration reduction sheet further comprises a second damping patch in contact with the substrate face, wherein the second damping patch is not in contact with the stiffening patch, and wherein the stiffening patch is located between the first and second damping patches along the substrate face.

In another embodiment the invention relates to a vibration reduction sheet comprising a damping patch and a stiffening patch that are in contact with one another and are not coextensive with one another. Preferably, the vibration reduction sheet further comprises a substrate connected to the free face of the damping patch, or the free face of the stiffening patch. Preferably, the damping patch comprises one or more of an adhesive, a thermoplastic polyurethane, foam, metal, composite, or a rubber. In some embodiments, the metal of the damping patch may be a soft metal, which are metals that have a Mohs scale of mineral hardness of about 4.0 or less. Preferably, the stiffening patch comprises a metal, a carbon fiber reinforced plastic, a glass fiber reinforced plastic, or a combination thereof The metal for the stiffening patch may be a soft metal or a hard metal, as defined above. In some embodiments, the damping patch comprises one or more layers of a damping material, and one or more layers of a stiffening material, wherein a majority of the thickness of the damping patch consists of the one or more layers of the damping material. In some embodiments, the stiffening patch comprises one or more layers of a stiffening material, and one or more layers of a damping material, wherein a majority of the thickness of the stiffening patch consists of the one or more layers of the stiffening material. Preferably, the ratio of the stiffening patch Young's modulus to the damping patch Young's modulus is greater than or equal to 2. More preferably, the ratio of the stiffening patch Young's modulus to the damping patch Young's modulus is greater than or equal to 10. Yet more preferably, the ratio of the stiffening patch Young's modulus to the damping patch Young's modulus is greater than or equal to 100. Even more preferably, the ratio of the stiffening patch Young's modulus to the damping patch Young's modulus is greater than or equal to 10,000. The vibration reduction sheet can preferably further comprise a substrate in contact with the damping patch opposite the stiffening patch, or in contact with the stiffening patch opposite the damping patch; an adhesive layer connected to the substrate opposite the damping patch and stiffening patch; and a liner layer connected to the adhesive layer opposite the substrate.

In another embodiment, the invention is to a method of reducing a vibration of a base structure. The method comprises providing a base structure that is subject to vibration. The base structure preferably comprises a metal or a polymer. Preferably, the metal is aluminum or steel. The base structure preferably is a component of a vehicle. Preferably, the vehicle is an automobile. The method further comprises connecting a vibration reduction sheet as described above to the base structure, thereby reducing the vibration of the base structure. In some embodiments, the base structure comprises a cantilever having a fixed end connected to a support, and a free end opposite the fixed end. In these embodiments, the stiffening patch is preferably disposed closer to the fixed end than the damping patch is. In some embodiments, the base structure comprises a beam or plate having a first fixed end connected to a first support, a second fixed end connected to a second support. In these embodiments, the damping patch can comprise a first damping patch, and the vibration reduction sheet can further comprise a second damping patch in connection with the base structure, wherein the first damping patch is disposed closer to the first fixed end than the stiffening patch is, and wherein the second damping patch is disposed closer to the second fixed end than the stiffening patch is. In some embodiments, the base structure comprises a plate having a plate perimeter, wherein a majority of the plate perimeter is connected to one or more supports. In some of these embodiments, substantially all of the plate perimeter is connected to the one or more supports. In some of these embodiments, the damping patch comprises a first damping patch, and the vibration reduction sheet further comprises a second damping patch in connection with the base structure, wherein the stiffening patch is located between the first and second damping patch along the substrate.

In another embodiment, the invention is to a vehicle comprising a vibration reduction as described above. Preferably, the vehicle is an automobile.

### BRIEF DESCRIPTION OF DRAWINGS

The invention is described in detail below with reference to the appended drawings, wherein like numerals designate similar parts.

FIG. 1 illustrates a vibration reduction sheet having a damping patch and a stiffening patch that do not contact one another.

FIG. 2 illustrates a cross-sectional view of a damping member in accordance with an embodiment.

FIG. 3 illustrates a cross-sectional view of a stiffening member in accordance with an embodiment.

FIG. 4 illustrates a vibration reduction sheet having a damping patch and a stiffening patch that do contact one another and that are not coextensive with one another.

FIG. 5A illustrates a cantilever beam in a neutral form and a vibrating form.

FIG. 5B illustrates the cantilever beam of FIG. 1A with the addition of a stiffening member used to reduce vibration.

FIG. 5C illustrates the cantilever beam and stiffening member of FIG. 1B with the addition of a vibration reduction sheet used to further reduce vibration in accordance with an embodiment.

FIG. 6A illustrates a fixed-fixed beam in a neutral form and a vibrating form.

FIG. 6B illustrates the fixed-fixed beam of FIG. 2A with the addition of a stiffening member used to reduce vibration.

FIG. 6C illustrates the fixed-fixed beam and stiffening member of FIG. 2B with the addition of a vibration reduction used to further reduce vibration in accordance with an embodiment.

FIG. 7A illustrates a fixed-fixed beam in a neutral form and a vibrating form.

FIG. 7B illustrates the fixed-fixed beam of FIG. 3A with the addition of a stiffening member used to reduce vibration.

FIG. 7C illustrates the fixed-fixed beam and stiffening member of FIG. 3B with the addition of a vibration reduction sheet having two damping members used to further reduce vibration in accordance with an embodiment.

FIG. 8A illustrates a cantilever plate in a neutral form and a vibrating form.

FIG. 8B illustrates the cantilever plate of FIG. 4A with the addition of a stiffening member used to reduce vibration.

FIG. 8C illustrates the cantilever plate and stiffening member of FIG. 4B with the addition of a vibration reduction sheet used to further reduce vibration in accordance with an embodiment.

FIG. 9A illustrates a fixed-fixed-fixed-fixed plate in a neutral form.

FIG. 9B illustrates the fixed-fixed-fixed-fixed plate of FIG. 5A with the addition of a stiffening member used to reduce vibration.

FIG. 9C illustrates the fixed-fixed-fixed-fixed plate and stiffening member of FIG. 5B with the addition of a vibration reduction sheet having four damping members used to further reduce vibration in accordance with an embodiment.

FIG. 10 illustrates a fixed-fixed-fixed-fixed plate having a stiffening member and a damping member surrounding the stiffening member in accordance with an embodiment.

### DETAILED DESCRIPTION OF THE INVENTION

The present invention generally relates to damping and stiffening materials and methods that, when employed, provide advantageous improvements in stiffness and reductions in vibration. For example, it is beneficial for a flexible or non-rigid structure to have the frequency and/or amplitude of any vibrations of the structure minimized. Such vibrational reductions beneficially increase the stability of the structure, reduce fatigue and stress, lengthen an operational lifetime, and decrease undesired vibration side effects, such as the generation of noise or the discomfort of vehicle passengers.

It is conventional for stiffening elements or damping elements to be attached to such vibrating structures to decrease the occurrence and intensity of observed vibrations. In these cases, the stiffening element and the damping element are typically applied together in a stacked configuration wherein the stiffening and damping elements are coextensive with one another. It is difficult, however, for such conventional approaches to address all vibrational issues associated with these structures. One reason for this is that, because of the coextensive configuration, the damping and stiffening elements in prior art systems are applied at the same location on a vibrating structure.

The inventors have now discovered that significant reductions in structural vibrations can be advantageously achieved by applying a damping patch and a stiffening patch to the structure at specific different locations or to different extents on the surface of the structure. In particular, it has been found that the effectiveness of damping and stiffening treatments can be synergistically enhanced if such treatments are strategically applied to different locations of the vibrating structure. By creating and using hybrid vibration reduction sheets that include one or more damping patches and one or more stiffening patches in particular configurations, one can increase the amount of vibrational energy that can be extracted from, and rigidity that can be added to, a system to which the sheet is applied, as compared to using the damping and stiffening patches in conventional configurations, e.g., the coextensive configuration.

Without being bound to a particular theory, it is believed that the stiffening, e.g., through the application of a stiffening patch, of a vibrating structure functions to reduce the amplitude of the structure vibrations, while the damping, e.g., through the application of a damping patch, of a vibrating structure functions to extract energy, e.g., in the form of heat loss, from the structure vibrations. Because the amount of energy that can be extracted from a vibrating system is related to the magnitude of the vibrational amplitude, a reduction in amplitude results in a related reduction in the amount of extractable energy. In this way, the effects of stiffening and damping will synergistically benefit one another, and this influence can be advantageously utilized in the combined vibration reduction approaches.

One technique useful for designing vibration reduction devices is to select the composition of a damping adhesive so as to have a rheological profile suitable for a particular desired vibrational frequency range and operating temperature range. Another technique involves adapting the construction, e.g., thickness or height, of stiffening and/or damping elements to influence their ability to reduce specific observed vibrations. It is common, however, for manufacturers of automobiles or other vibrating products to have size and weight requirements that can limit the degree to which stiffening or damping patch constructions can be adapted. Another approach that is enabled with the provided devices and methods, is to position stiffening and damping patches at locations that are different from one another. This allows a user to add both stiffening and damping patches, for example as elements of a single hybrid vibration reduction sheet, at separate locations on a vibrating base structure so as to provide a more optimized and synergistic effect. These resulting combined synergistic effects are not seen with conventional vibration reduction approaches.

In one embodiment, a vibration reduction sheet is disclosed. The vibration reduction sheet comprises a damping patch and a stiffening patch, each respectively having its Young's modulus. In some cases, the damping patch and the stiffening patch are not in contact with one another. The Young's modulus of the stiffening patch is greater than that of the damping patch. The ratio of the stiffening patch Young's modulus to the damping patch Young's modulus may be greater than or equal to 2. Yet more preferably, the ratio of the stiffening patch Young's modulus to the damping patch Young's modulus is greater than or equal to 100. Even more preferably, the ratio of the stiffening patch Young's modulus to the damping patch Young's modulus is greater than or equal to 10,000. Preferably, the vibration reduction sheet comprises a substrate, e.g., a liner, which has a substrate face. The substrate, e.g., the substrate face, may be in contact with both the stiffening patch and the damping patch.

In one embodiment, another vibration reduction sheet is disclosed. The vibration reduction sheet comprises a damping patch and a stiffening patch, each respectively having its Young's modulus. In some cases, the damping patch and the stiffening patch are not coextensive, e.g., all of the damping patch is not in contact with all of the stiffening patch. As was the case above, the Young's modulus of the stiffening patch is greater than that of the damping patch. In some embodiments, the ratio of the stiffening patch Young's modulus to the damping patch Young's modulus may be greater than or equal to 2. Yet more preferably, the ratio of the stiffening patch Young's modulus to the damping patch Young's modulus is greater than or equal to 100. Even more preferably, the ratio of the stiffening patch Young's modulus to the damping patch Young's modulus is greater than or equal to 10,000.

As used herein, the term “coextensive” refers to a relationship between two or more layers such that the surface areas of adjacent or parallel faces of the layers are aligned with one another with little or no overhang (of at least one of the areas or layers). In some cases, the areas or faces are within 90% of one another, for example, two or more layers are coextensive if the surface areas of adjacent or parallel faces of the layers are within 90%, within 92%, within 94%, within 96%, or within 98% of one another. The term “coextensive” can also refer to a relationship between two or more layers such that the lengths of the layers are within 90% of one another. For example, two or more layers are coextensive if the lengths of the layers are within 90%, within 92%, within 94%, within 96%, or within 98% of one another. The term “coextensive” can also refer to a relationship between two or more layers such that the widths of the layers are within 90% of one another. For example, two or more layers are coextensive if the widths of the layers are within 90%, within 92%, within 94%, within 96%, or within 98% of one another.

The substrate to which the damping patch and stiffening patch are applied can be a polymeric film, such as a polyester, polyethylene, polypropylene, polyurethane, or polyvinyl chloride film, or a multilayer film or blends of one or more of these. The substrate can also be a release liner, or paper substrate. Suitable substrate forms include, but are not limited to film form, felt, woven, knitted, non-woven, scrim, foamed, or cavitated. Other substrates include, but are not limited to, metal or foil such as aluminum, steel, and stainless steel, with or without a coating overlying the metal. The substrate can be a transfer tape, having a single coated or double coated construction with one or two liners.

The composition of the damping patch is selected for increased damping properties. The damping patch can include, for example, one or more adhesives, one or more rubbers, polyurethane, or a mixture or combination thereof. The damping patch can have a lower Young's modulus E, shear modulus G, and/or a higher Poisson ratio, than the stiffening patch. In some embodiments, the damping patch has a Young's modulus E ranging from 0.001 to 10 GPa, e.g., from 0.001 GPa to 0.25 GPa, from 0.0025 GPa to 0.65 GPa, from 0.0065 GPa to 1.5 GPa, from 0.015 GPa to 4 GPa, or from 0.04 GPa to 10 GPa. In terms of upper limits, the damping patch can have a Young's modulus that is less than 10 GPa, e.g., less than 4 GPa, less than 1.5 GPa, less than 0.65 GPa, less than 0.25 GPa, less than 0.1 GPa, less than 0.04 GPa, less than 0.0015 GPa, less than 0.0065 GPa, or less than 0.0025 GPa. In terms of lower limits, the damping patch can have a Young's modulus that is greater than 0.001 GPa, e.g., greater than 0.0025 GPa, greater than 0.0065 GPa, greater than 0.015 GPa, greater than 0.04 GPa, greater than 0.1 GPa, greater than 0.25 GPa, greater than 0.65 GPa, greater than 1.5 GPa, or greater than 4 GPa.

In some embodiments, the damping patch has a shear modulus ranging from 0.0003 to 3 GPa, e.g., from 0.0003 GPa to 0.08 GPa, from 0.0008 GPa to 0.2 GPa, from 0.002 GPa to 0.5 GPa, from 0.005 GPa to 1.5 GPa, or from 0.015 GPa to 3 GPa. In terms of upper limits, the damping patch can have a shear modulus that is less than 3 GPa, e.g., less than 1.5 GPa, less than 0.5 GPa, less than 0.2 GPa, less than 0.08 GPa, less than 0.04 GPa, less than 0.015 GPa, less than 0.005 GPa, less than 0.002 GPa, or less than 0.0008 GPa. In terms of lower limits, the damping patch can have a shear modulus that is greater than 0.0001 GPa, e.g., greater than 0.0008 GPa, greater than 0.002 GPa, greater than 0.005 GPa, greater than 0.015 GPa, greater than 0.04 GPa, greater than 0.08 GPa, greater than 0.2 GPa, greater than 0.5 GPa, or greater than 1.5 GPa.

In some embodiments, the damping patch has a Poisson ratio ranging from 0.3 to 0.5, e.g., from 0.3 to 0.42, from 0.32 to 0.44, from 0.34 to 0.46, from 0.36 to 0.48, or from 0.38 to 0.5. In terms of upper limits, the damping patch can have a Poisson ratio that is less than 0.5, e.g., less than 0.48, less than 0.46, less than 0.44, less than 0.42, less than 0.4, less than 0.38, less than 0.36, less than 0.34, or less than 0.32. In terms of lower limits, the damping patch can have a Poisson ratio that is greater the 0.3, e.g., greater than 0.32, greater than 0.34, greater than 0.36, greater than 0.38, greater than 0.4, greater than 0.42, greater than 0.44, greater than 0.46, or greater than 0.48.

The compositions of the stiffening patch are selected for increased stiffening properties. The stiffening patch can include, for example, one or more metals, one or more fiber reinforced plastics like carbon fiber reinforced plastics or glass fiber reinforced plastics, or a combination thereof The stiffening patch can have a higher Young's modulus E and shear modulus G, and a lower Poisson ratio, than the damping patch. In some embodiments, the stiffening member has a Young's modulus E ranging from 10 to 1000 GPa, e.g., from 10 GPa to 150 GPa, from 15 GPa to 250 GPa, from 25 GPa to 400 GPa, from 40 GPa to 650 GPa, or from 65 GPa to 1000 GPa. In terms of upper limits, the stiffening patch can have a Young's modulus that is less than 1000 GPa, e.g., less than 650 GPa, less than 400 GPa, less than 250 GPa, less than 150 GPa, less than 100 GPa, less than 65 GPa, less than 40 GPa, less than 25 GPa, or less than 15 GPa. In terms of lower limits, the stiffening patch can have a Young's modulus that is greater than 10 GPa, e.g., greater than 15 GPa, greater than 25 GPa, greater than 40 GPa, greater than 65 GPa, greater than 100 GPa, greater than 150 GPa, greater than 250 GPa, greater than 400 GPa, greater than 650 GPa, or greater than 1000 GPa.

In some embodiments, the stiffening patch has a shear modulus ranging from 3 GPa to 300 GPa, e.g., from 3 GPa to 50 GPa, from 5 GPa to 75 GPa, from 7.5 GPa to 100 GPa, from 10 GPa to 200 GPa, or from 20 GPa to 300 GPa. In terms of upper limits, the stiffening patch can have a shear modulus that is less than 300 GPa, e.g., less than 200 GPa, less than 100 GPa, less than 75 GPa, less than 50 GPa, less than 30 GPa, less than 20 GPa, less than 10 GPa, less than 7.5 GPa, or less than 5 GPa. In terms of lower limits, the stiffening patch can have a shear modulus that is greater than 3 GPa, e.g., greater than 5 GPa, greater than 7.5 GPa, greater than 10 GPa, greater than 20 GPa, greater than 30 GPa, greater than 50 GPa, greater than 75 GPa, greater than 100 GPa, or greater than 200 GPa.

In some embodiments, the stiffening patch has a Poisson ratio ranging from 0.2 to 0.4, e.g., from 0.2 to 0.32, from 0.22 to 0.34, from 0.24 to 0.36, from 0.26 to 0.38, or from 0.28 to 0.4. In terms of upper limits, the stiffening patch can have a Poisson ratio that is less than 0.4, e.g., less than 0.38, less than 0.36, less than 0.34, less than 0.32, less than 0.3, less than 0.28, less than 0.26, less than 0.24, or less than 0.22. In terms of lower limits, the stiffening patch can have a Poisson ratio that is greater than 0.2, e.g., greater than 0.22, greater than 0.24, greater than 0.26, greater than 0.28, greater than 0.3, greater than 0.32, greater than 0.34, greater than 0.36, or greater than 0.38. In other embodiments, the stiffening patch has a Poisson ratio ranging from −1.0 to 0.5, e.g., from 0.3 to 0.42, from 0.32 to 0.44, from 0.34 to 0.46, from 0.36 to 0.48, from 0.38 to 0.5, from 0 to 0.1, from 0.1 to 0.15, from 0.15 to 0.25, and from −1.0 to about 0.

By selecting the particular properties of the damping and stiffening patches, the vibration reduction sheets are beneficially able to extract greater amounts of vibrational energy from the system. In fact, the inventors have found that due to the configuration of the vibration reduction sheets, greater vibrational energy is extracted from a system, as compared to a conventional coextensive damping/stiffening sheet. In some embodiments, the provided vibration reduction sheets improve damping relative to a conventional damping patch by at least 5%, at least 10%, at least 15%, at least 20%, at least 25%, or at least 30% as measured with the VBT test of ASTM standard test method E756-05.

In some embodiments, the ratio of the stiffening patch Young's modulus to the damping patch Young's modulus ranges from 2 to 1,000,000, e.g., from 100 to 25,000, from 250 to 65,000, from 650 to 150,000, from 1500 to 400,000, or from 4000 to 1,000,000. In terms of upper limits, the ratio of the stiffening patch Young's modulus to the damping patch Young's modulus can be less than 1,000,000, e.g., less than 400,000, less than 150,000, less than 65,000, less than 25,000, less than 10,000, less than 4000, less than 1500, less than 650, or less than 250. In terms of upper limits, the ratio of the stiffening patch Young's modulus to the damping patch Young's modulus can be greater than 2, e.g., greater than 100, greater than 250, greater than 650, greater than 1500, greater then 4000, greater than 10,000, greater than 25,000, greater than 65,000, greater than 150,000, or greater than 400,000.

In some embodiments, the ratio of the stiffening patch shear modulus to the damping patch shear modulus ranges from 1000 to 10,000, e.g., from 1000 to 4000, from 1300 to 5000, from 1600 to 6000, from 2000 to 8000, or from 2500 to 10,000. In terms of upper limits, the ratio of the stiffening patch shear modulus to the damping patch shear modulus can be less than 10,000, e.g., less than 8000, less than 6000, less than 5000, less than 4000, less than 3000, less than 2500, less than 2000, less than 1600, or less than 1300. In terms of upper limits, the ratio of the stiffening patch shear modulus to the damping patch shear modulus can be greater than 1000, e.g., greater than 1300, greater than 1600, greater than 2000, greater than 2500, greater then 3000, greater than 4000, greater than 5000, greater than 6000, or greater than 8000.

In some embodiments, an adhesive layer is connected to the substrate, opposite the damping patch and the stiffening patch. The adhesive layer can include one or more sublayers with different adhesive compositions or properties, and can include, for example, one or more pressure sensitive adhesives.

In some embodiments, a release liner is connected to the adhesive layer opposite the substrate. The releasable liner can function as a protective cover such that the release liner remains in place until the sheet is ready for attachment to an object or surface. If a liner or release liner is included in the sheet, a wide array of materials and configurations can be used for the liner. In many embodiments, the liner is a paper or paper-based material. In many other embodiments, the liner is a polymeric film of one or more polymeric materials. Typically, at least one face of the liner is coated with a release material such as a silicone or silicone-based material. As will be appreciated, the release coated face of the liner is placed in contact with the otherwise exposed face of the outer adhesive layer. Prior to application of the label to a surface of interest, the liner is removed to thereby expose the adhesive face of the label. The liner can be in the form of a single sheet. Alternatively, the liner can be in the form of multiple sections or panels.

In some embodiments, the damping patch surrounds or substantially surrounds the stiffening patch. In some embodiments, the damping patch comprises a first damping patch, wherein the vibration reduction sheet further comprises a second damping patch in contact with the substrate face, wherein the second damping patch is not in contact with the stiffening patch, and wherein the stiffening patch is located between the first and second damping patches along the substrate face.

### Stiffening Materials

The stiffening patch comprises one or more layers of a stiffening material, wherein each of the layers can have a similar or different composition. The stiffening materials can include one or more polymeric materials. Nonlimiting examples of polymeric materials include polyvinyl chloride (PVC), polyolefins such as polyethylene (PE) and/or polypropylene (PP), polyethylene terephthalate (PET), polycarbonate (PC), polystyrene (PS), and combinations of these and other materials. The stiffening materials can include one or more metals or metal alloys. Nonlimiting examples of metals include aluminum, steel, magnesium, bronze, copper, brass, titanium, iron, beryllium, molybdenum, tungsten, or osmium. The metal for the stiffening material may be a soft metal or a hard metal. The stiffening materials can include one or more natural or manufactured woods. The stiffening materials can include one or more fibers. Nonlimiting examples of fibers include hemp fibers, flax fibers, glass fibers, and carbon fibers. The stiffening materials can include one or more carbon based materials, including carbon nanotubes, graphene, diamond, carbine, or combinations thereof. Composite materials and combinations of these materials could also be used. In some embodiments, the stiffening patch also includes one or more layers of a damping material, wherein a majority of the thickness of the stiffening patch consists of the one or more layers of the stiffening material. In these embodiments, the one or more layers of the damping material are coextensive or substantially coextensive with the one or more layers of the stiffening material, such that the damping material layers are elements of the stiffening patch and not of a separate damping patch.

### Damping Materials

The damping patch comprises one or more layers of a damping material, wherein each of the layers can have a similar or different composition. The damping materials can include elastic, anelastic, viscous, and/or viscoelastic materials. For instance, the material can be compressible and can comprise a restorative force. In an aspect, the damping materials can include rubber, plastic (e.g., nylon), leather, fabric, foam, sponge, gel, or the like. In some embodiments, the damping patch also includes one or more layers of a stiffening material, wherein a majority of the thickness of the damping patch consists of the one or more layers of the damping material. In these embodiments, the one or more layers of the stiffening material are coextensive or substantially coextensive with the one or more layers of the damping material, such that the stiffening material layers are elements of the damping patch and not of a separate stiffening patch.

In some embodiments, the damping patch and damping material includes one or more adhesives selected for their material loss factor properties. The material loss factor is an indication of the vibration (and sound) damping properties of a material. The composite loss factor (CLF) is a measure of the conversion of vibrational energy to thermal energy. A conventional high damping material composition is generally required to have a material loss factor of not less than 0.8. In a layer construction, the total composite loss factor, including the substrate and the viscoelastic damping material, is generally required to be not less than 0.1.

In some embodiments, the damping patch of the present subject matter when used in an assembly exhibit a peak composite loss factor greater than 0.1. In a particular embodiment, the damping patch exhibits a composite loss factor greater than 0.10 at 50 Hz, and/or a composite loss factor greater than 0.05 at a frequency of 8000 Hz. Determination of composite loss factors is described in ASTM E 756-98, “Standard Test Method for Measuring Vibration-Damping Properties of Materials.” In some embodiments, the damping patch of the present subject matter exhibits good damping performance across the audible spectrum, which is generally considered to range from 20 Hz to 20,000 Hz, and at temperatures within a range of from about 50° F. (10° C.) to about 150° F. (65.5° C.).

The damping materials can include one or more silicone adhesives. The silicone adhesives can include polyorganosiloxane dispersions or gums, such as polydimethylsiloxanes, polydimethyl/methylvinyl siloxanes, polydimethyl/methylphenyl siloxanes, polydimethyl/diphenyl siloxanes, and blends thereof The silicone adhesives can include silicone resins, such as MQ resins or blends of resins. Non-limiting examples of such silicone adhesive compositions which are commercially available include adhesives, 7651, 7652, 7657, Q2-7406, Q2-7566, Q2-7735 and 7956, all available from Dow Corning, SilGrip™ PSA518, 590, 595, 610, 915, 950 and 6574 available from Momentive Performance Materials, and KRT-009 and KRT-026 available from Shin-Etsu Silicone.

The damping materials can comprise an acrylic-based or silicone-based monomer. In some embodiments, the damping materials comprise one or more acrylic-based monomers selected from the group consisting of methyl acrylate, ethyl acrylate, butyl acrylate, 2-ethylhexyl acrylate, isooctyl acrylate, isobornyl acrylate, isononyl acrylate, isodecyl acrylate, methylacrylate, methyl methacrylate, methylbutyl acrylate, 4-methyl-2-pentyl acrylate, butyl methacrylate, 2-ethylhexyl methacrylate, and isooctyl methacrylate. Useful alkyl acrylate esters include n-butyl acrylate, 2-ethyl hexyl acrylate, isooctyl acrylate. In one embodiment, the acrylic ester monomer is polymerized in the presence of a vinyl ester such as vinyl acetate, vinyl butyrate, vinyl propionate, vinyl isobutyrate, vinyl valerate, vinyl versitate, and the like. The vinyl ester may be present in a total amount of up to about 35 weight percent, based on total weight of the monomers forming the acrylate main chain. In one embodiment, an acrylic ester monomer is copolymerized with an unsaturated carboxylic acid. The unsaturated carboxylic acid can include, among others, acrylic acid, methacrylic acid, itaconic acid, beta carboxy ethyl acrylate and the like.

In some embodiments, the damping materials comprise one or more silicone-based monomers selected from the group consisting of siloxanes, silane, and silatrane glycol. In some embodiments, the damping materials comprise one or more silicone-based monomers selected from the group consisting of 1,4-bis[dimethyl[2-(5-norbornen-2-yl)ethyl]silyl]benzene; 1,3-dicyclohexyl-1,1,3,3-tetrakis(dimethylsilyloxy)disiloxane; 1,3-dicyclohexyl-1,1,3,3-tetrakis(dimethylvinylsilyloxy)disiloxane; 1,3-dicyclohexyl-1,1,3,3-tetrakis[(norbornen-2-yl)ethyldimethylsilyloxy]disiloxane; 1,3-divinyltetramethyldisiloxane; 1,1,3,3,5,5-hexamethyl-1,5-bis[2-(5-norbornen-2-yl)ethyl]trisiloxane; 1,1,3,3-tetramethyl-1,3-bis[2-(5-norbornen-2-yl)ethyl]disiloxane; 2,4,6,8-tetramethyl-2,4,6,8- tetravinylcyclotetrasiloxane; N-[3-(trimethoxysilyl)propyl]-N′-(4-vinylbenzyl)ethylenediamine; and 3-[tris(trimethylsiloxy)silyl]propyl vinyl carbamate.

The damping materials can comprise a silicone polymer, an acrylic polymer, or a methacrylic polymer. Suitable acrylic polymers include, but are not limited to, S2000N, S692N, AT20N, XPE 1043, and XPE 1045, all available from Avery Dennison; and H9232 available from BASF. In one embodiment, the acrylic polymer composition is blended with multiblock copolymers such as, styreneisoprene-styrene (SIS), styrene-ethylenebutylene-styrene (SEBS) and the like in an amount of up to 30% by dry weight of the polymer. Examples of useful triblocks are available from Kraton Polymer Inc., Houston, Tex. Multiblock polymers can be useful in modifying the damping peak and other physical properties of the acrylic composition.

A wide array of functional groups can be incorporated in a polymer of the damping materials. The functional groups can be incorporated into the polymer formed from the acrylic-based monomer or the silicon-based monomer, for example as end segments. Representative functional groups include, without limitation, hydroxy, epoxy, cyano, isocyanate, amino, aryloxy, aryalkoxy, oxime, aceto, epoxyether and vinyl ether, alkoxymethylol, cyclic ethers, thiols, benzophenone, acetophenone, acyl phosphine, thioxanthone, and derivatives of benzophenone, acetophenone, acyl phosphine, and thioxanthone.

Functional groups that have hydrogen-bonding capability are well known and include carboxyl, amide, hydroxyl, amino, pyridyl, oxy, carbamoyl and mixtures thereof. In some embodiments, an acrylic polymer backbone of the damping materials includes the polar comonomers vinyl pyrrolidone and acrylic acid. Examples of other monomers with hydrogen-bonding functionality include methacrylic acid, vinyl alcohol, caprolactone, ethylene oxide, ethylene glycol, propylene glycol, 2-hydroxyethyl acrylate, N-vinyl caprolactam, acetoacetoxyethyl methacrylate and others.

In some embodiments, the damping materials comprise one or more co-monomers bearing a functionality that can be further crosslinked. Examples of crosslinkable co-monomers include (meth) acrylic acid, 2-hydroxyethyl acrylate, glycidyl methacrylate, itaconic acid, allyl glycidyl ether and the like, and mixtures thereof Functional moieties, such as those described above, can be used to crosslink polymer chains, to attach the high side chains to the backbone, or both.

The damping materials can further comprise a crosslinker, which may vary widely. Examples of suitable crosslinkers include multifunctional acrylates and methacrylates, such as diacrylates (ethylene glycol diacrylate, propylene glycol diacrylate, polyethylene glycol diacrylate, and hexanediol diacrylate), dimethacrylates (ethylene glycol diacrylate, diethylene glycol dimethacrylate, and 1,3 butane glycol dimethacrylate), triacrylates (trimethylolpropane trimethacrylate, ethoxylated trimethylolpropane triacrylate, and pentaerythritol triacrylate), and trimethacrylates (pentaerythritol trimethacrylate and trimethylolpropane trimethacrylate), as well as divinyl esters, such as divinylbenzene, divinyl succinate, divinyl adipate, divinyl maleate, divinyl oxalate, and divinyl malonate.

Additional crosslinkers present in the damping materials can serve to form crosslinks in a silicone-based matrix. In some embodiments, a peroxide crosslinker, such as dibenzoylperoxide, is suitable. In some embodiments, the crosslinker is a compound that contains silicon-hydride functionality. Non-limiting examples of such crosslinkers include PEROXAN BP 50W, PEROXAN BIC, and PEROXAN Bu, all available from Pergan of Bocholt, Germany, and Luperox A75 and A98 commercially available from Arkema, and Perkadox CH-50 and PD 50SPS from Akzo Nobel. Crosslinking can be facilitated and/or promoted by heating or other techniques generally depending upon the chemical system employed.

Other exemplary chemical crosslinkers that can be used in the damping materials include, but are not limited to, di-, tri- or poly-isocyanates with or without a catalyst (such as dibutyltin dilaureate); ionic crosslinkers; and di-, tri- or poly-functional aziridines. Illustrative, non-limiting examples of commercially available chemical crosslinkers include aluminum acetyl acetonate (AAA) available from NOAH Technologies of San Antonio, Tex., Tyzor available from DuPont of Wilmington, Del., XAMA available from Bayer of Pittsburgh, Pa., and PAPI and Voronate, available from Dow Chemical.

The damping materials can optionally comprise one or more tackifiers or resins, and these tackifiers (when employed) can vary widely. In some cases, the tackifier of the damping materials includes a single tackifier. In other cases, the tackifier comprises a mixture of multiple tackifier products. Suitable commercial tackifiers include (but are not limited to), for example, hydrogenated DCPD resins such as HD1100, HD1120 from Luhua, and E5400 from Exxon Mobil. Other suitable hydrogenated resins include fully hydrogenated resins such as Regalite S1100, R1090, R1100, C100R, and C100W from Eastman, and fully hydrogenated C9 resins QM-100A and QM-115A from Hebei Qiming.

The damping materials can also optionally comprise one or more plasticizers, and these plasticizers (when employed) can vary widely. In some embodiments, the plasticizer has a high molecular weight and/or a high viscosity. In some cases, the plasticizer includes a single plasticizer. In other cases, the plasticizer comprises a mixture of multiple plasticizer products. Suitable commercial plasticizers include (but are not limited to), for example, KN 4010 and KP 6030 from Sinopec, Claire F55 from Tianjin, F550 from Formosa Petrochemical Corp., and various polyisobutene products.

The damping materials can optionally comprise one or more waxes, and these waxes (when employed) can vary widely. In some cases, the wax includes a single wax. In other cases, the wax comprises a mixture of multiple wax products. The wax can have a higher molecular weight so as to advantageously improve oil migration. Exemplary waxes include microcrystalline waxes, paraffin waxes, hydrocarbon waxes, and combinations thereof. Suitable commercial waxes include (but are not limited to), for example, Sasol wax 3971, 7835, 6403, 6805, and 1800 from Sasol; A-C1702, A-C6702, A-C5180 from Honeywell; and Microwax FG 7730 and Microwax FG 8113 from Paramelt Specialty Materials (Suzhou) Co. Ltd.

The damping materials can comprise one or more powder additives selected to improve damping performance across a broader range of operating temperatures. In some embodiments, the damping materials comprise one or more acrylic-based powder additives. Suitable commercially available acrylic-base powder additives include SPHEROMERS® CA 6, SPHEROMERS® CA 10, SPHEROMERS® CA 15, KRATON® SBS 1101 AS, KRATON® SB 1011 AC, KRATON® TM 1116 Polymer, KRATON® D1101 A Polymer, KRATON® D1114 P Polymer KRATON® D1114 P Polymer, Zeon NIPOL® 1052, Zeon NIPOL® 1041, and Zeon NIPOL® NS 612. In some embodiments, the damping materials comprise one or more silicone-based powder additives. Suitable commercially available silicone-base powder additives include Shin-Etsu KMP 597, Shin-Etsu KMP 600, and Shin-Etsu KMP 701.

In some embodiments, the damping materials include one or more high surface area inorganic fillers such as carbon black, silica (hydrophilic and hydrophobic modified), mica, talc, kaolin and the like. Examples of commercially available high surface area inorganic fillers include those available from Evonik Degussa GmbH (Germany). Inorganic fillers including the foregoing examples can be used to modulate the damping and other physical properties of the damping patch.

Metallic particulates can be used in the damping materials, for example, metal powders such as aluminum, copper or special steel, molybdenum disulphide, iron oxide, e.g., black iron oxide, antimony-doped titanium dioxide and nickel doped titanium dioxide. Metal alloy particulates can also be used.

Additives, such as pigments, ultraviolet light absorbers, ultraviolet stabilizers, antioxidants, fire retardant agents, thermally or electrically conductive agents, post curing agents, and the like can be blended into the damping materials to modify the properties of the damping patch. These additives can also include, for example, one or more inhibitors, defoamers, colorants, luminescents, buffer agents, anti-blocking agents, wetting agents, matting agents, antistatic agents, acid scavengers, processing aids, extrusion aids, and others. Ultraviolet light absorbers include hydroxyphenyl benzotriazoles and hydrobenzophenones. Antioxidants include, for example, hindered phenols, amines, and sulfur and phosphorus hydroxide decomposers, such as Irganox 1520L.

The damping materials can also comprise one or more solvents. Nonlimiting examples of suitable solvents include toluene, xylene, tetrahydrofuran, hexane, heptane, cyclohexane, cyclohexanone, methylene chloride, isopropanol, ethanol, ethyl acetate, butyl acetate, isopropyl acetate, and combinations thereof. It will be appreciated that the present subject matter damping materials are not limited to such solvents and can utilize a wide array of other solvents, additives, and/or viscosity adjusting agents, such as reactive diluents.

### Configurations

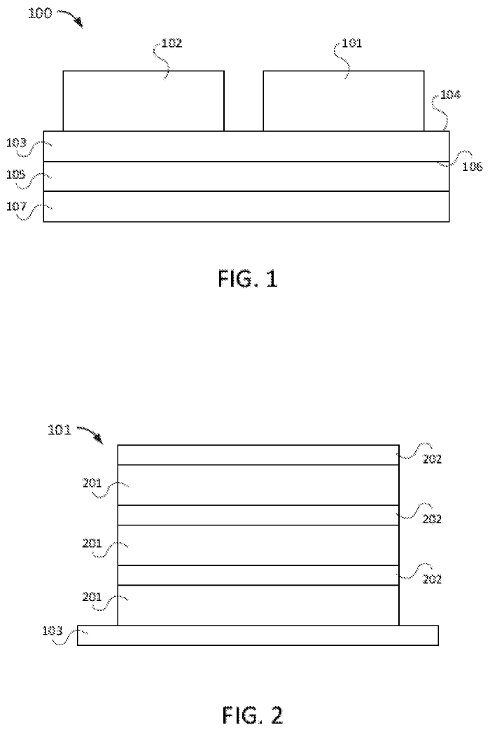

FIG. 1 illustrates one provided embodiment of a vibration reduction sheet. Shown in the figure is a vibration reduction sheet 100 comprising a damping patch 101, a stiffening patch 102, and a substrate 103. The substrate has a substrate face 104 that is contact with the damping patch and the stiffening patch. The damping patch and the substrate patch are not in contact with one another. The damping patch and the substrate patch can each comprise an adhesive layer that is used to adhere the patches to the substrate. In some embodiments, and as is shown in FIG. 1, an adhesive layer 105 is connected to an adhesive face 106 of the substrate 103. A liner layer 107 can also be connected to the adhesive layer. In this way, the vibration reduction sheet can be configured as a label that can be applied to a base structure for the purpose of minimizing the structure vibrations.

FIG. 2 illustrates a cross-sectional view of the damping patch 101 of FIG. 1. In some embodiments, and as shown in FIG. 2, the damping patch includes multiple layers of damping material 201. Each layer of the damping material can have a similar or a different composition or thickness from one or more other layers of damping material within the damping patch. In some embodiments, the damping patch includes only a single layer of damping material. In some embodiments, the damping patch consists of a single layer of damping material. In some embodiments, and as shown in FIG. 2, the damping patch also includes multiple layers of stiffening material 202. The stiffening material can be used, for example, to provide structural integrity to the damping patch. In these embodiments, the one or more layers of the stiffening material are coextensive or substantially coextensive with the one or more layers of the damping material, such that the stiffening material layers are elements of the damping patch and not of a separate stiffening patch. Each layer of the stiffening material can have a similar or a different composition or thickness from one or more other layers of stiffening material within the damping patch. In some embodiments, the damping patch includes only a single layer of stiffening material. In some embodiments, the damping patch does not include a layer of stiffening material. The damping material and stiffening material are selected to have properties as described above. For example, the damping material can have a lower Young's modulus, a lower shear modulus, and/or a higher Poisson ratio than the stiffening material of the damping patch. The number and order of layers within the damping patch can be varied according to suitability for a particular application, with the majority of the overall thickness of the damping patch consisting of the one or more layers of the damping material. The damping patch can include other layers not shown, including an adhesive layer for attaching the damping patch to the substrate 103 as discussed above.

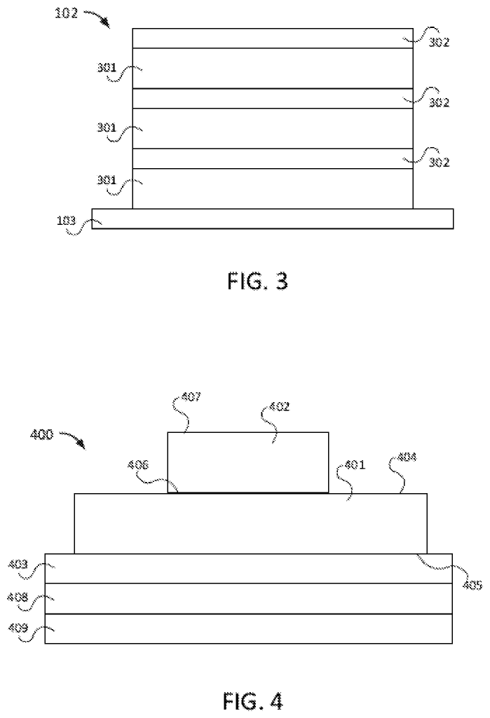

FIG. 3 illustrates a cross-sectional view of the stiffening patch 102 of FIG. 1. In some embodiments, and as shown in FIG. 3, the stiffening patch includes multiple layers of stiffening material 301. Each layer of the stiffening material can have a similar or a different composition or thickness from one or more other layers of stiffening material within the stiffening patch. In some embodiments, the stiffening patch includes only a single layer of stiffening material. In some embodiments, the stiffening patch consists of a single layer of stiffening material. In some embodiments, and as shown in FIG. 3, the stiffening patch also includes multiple layers of damping material 302. The damping material can provide, for example, adhesion or elasticity to the stiffening patch. In these embodiments, the one or more layers of the damping material are coextensive or substantially coextensive with the one or more layers of the stiffening material, such that the damping material layers are elements of the stiffening patch and not of a separate damping patch. Each layer of the damping material can have a similar or a different composition or thickness from one or more other layers of damping material within the stiffening patch. In some embodiments, the stiffening patch includes only a single layer of damping material. In some embodiments, the stiffening patch does not include a layer of damping material. The stiffening material and damping material are selected to have properties as described above. For example, the stiffening material can have a higher Young's modulus, a higher shear modulus, and/or a lower Poisson ratio than the damping material of the stiffening patch. The number and order of layers within the stiffening patch can be varied according to suitability for a particular application, with the majority of the overall thickness of the stiffening patch consisting of the one or more layers of the stiffening material. The stiffening patch can include other layers not shown, including an adhesive layer for attaching the damping patch to the substrate 103 as discussed above.

FIG. 4 illustrates another provided embodiment of a vibration reduction sheet. Shown in the figure is a vibration reduction sheet 400 comprising a damping patch 401, a stiffening patch 402, and a substrate 403. The damping patch has a connected damping face 404 and an opposite free damping face 405. The stiffening face has a connected stiffening face 406 and an opposite free stiffening face 407. In some embodiments, and as shown in FIG. 4, the damping patch has a longer length than that of the stiffening patch. In these cases, a portion of the connected damping face is in contact with the connected stiffening face, such that a majority of the connected damping face is not in contact with the connected stiffening face. In alternative embodiments, the stiffening patch has a longer length than that of the damping patch. In these cases, a portion of the connected stiffening face is in contact with the connected damping face, such that a majority of the connected stiffening face is not in contact with the connected damping face. In some embodiments, and as shown in FIG. 4, the substrate is connected to the free damping face. In alternative embodiments, the substrate is connected to the free stiffening face. The damping patch or the substrate patch can comprise an adhesive layer that is used to adhere the patch to the substrate. In some embodiments, and as is shown in FIG. 4, an adhesive layer 408 is connected to the substrate. A liner layer 409 can also be connected to the adhesive layer. In this way, the vibration reduction sheet can be configured as a label that can be applied to a base structure for the purpose of minimizing the structure vibrations.

Also provided are methods of reducing the vibration of a base structure. The methods comprise providing a base structure and any of the vibration reduction sheets described above. The methods further comprise connecting the substrate of the vibration reduction sheet to the base structure. In some embodiments, the method further comprises removing a liner layer from the vibration reduction sheet to expose an adhesive layer, and then adhering the adhesive layer to the base structure, thereby connecting the substrate to the base structure. The preferred placement of the vibration reduction sheet on the base structure will vary with the composition and form of the base structure as described in more detail below.

The base structure can comprise one or metals, one or more polymers, or composite or constructed compositions that are increasing finding application in, for example, the automotive industry, as replacements for conventional metals and polymers. In some embodiments, the base structure comprises a metal. In some embodiments, the base structure comprises steel or aluminum. In some embodiments, the base structure is a component of a vehicle, such as an automobile, and can include a part of a body panel, a frame member, or another structural component.

The structural design of the base structure may be classified in to two basic kinds of systems, based on their load and support placements. The first classification is similar to cantilever beam based structures, in which a portion of the structure is free or could experience loads at this location, and another portion of the structure is supported, held, or attached at a different location. In these structures the stiffening patch of the vibration reduction sheet can be positioned proximate to the support so as to reduce the amplitude of vibration at the free end. The maximum deflection of cantilever structures typically occurs at the free end of the structure. As a result, the damping patch of the vibration reduction sheet can be applied proximate to the free end as a particularly effective damping treatment.

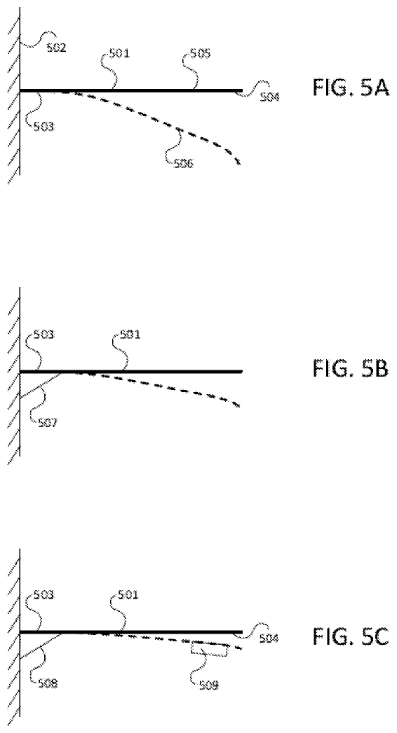

FIG. 5A illustrates a cantilever beam 501 that is connected to a support 502. The cantilever beam has a fixed end 503 that is the end of the beam that is connected to the support, and a free end 504 that is opposite the fixed end. The cantilever beam has a neutral form 505, and a vibrating form 506 that represents one of the forms of the beam as it vibrates. In some embodiments, and as is shown in FIG. 5A, the neutral form of the cantilever beam is linear or substantially linear. Alternatively, the cantilever beam can have a different form that comprises one or more curves or angles. Because the fixed end of the cantilever beam is connected to the support, the free end of the beam typically exhibits the greatest displacement between the neutral form and the vibrating form as the beam vibrates. The system depicted in FIG. 5A does not include the provided vibration reduction sheet, and as a results does not demonstrate the synergistic effects of a damping patch and a stiffening patch applied at different locations or extents.

FIG. 5B illustrates the cantilever beam 501 of FIG. 5A, to which a stiffening patch 507 has been added using conventional methods and materials. In some embodiments, and as shown in FIG. 1B, the stiffening patch is attached to the beam at a location that is proximate to the fixed end 503 of the beam. The stiffening patch can comprise a material that is generally stiffer than the material of the beam. In this manner, the stiffening patch can comprise a rigid structure that can contribute to altering noise produced from vibrations. The system depicted in FIG. 5B does not include the provided vibration reduction sheet, and as a results does not demonstrate the synergistic effects of a damping patch and a stiffening patch applied at different locations or extents.

FIG. 5C illustrates the cantilever beam 501 of FIG. 5A, to which a provided vibration reduction sheet, such as sheet 100 of FIG. 1, has been added. The sheet is applied to the base structure beam such that the stiffening patch 508 is closer to the fixed end 503 of the beam, and the damping patch 509 is closer to the free end 504. Through the application of this single hybrid construction, the stiffening patch and the damping patch are each connected to the base structure at locations where they will independently be the most effective as discussed above. The stiffening patch can, for example, be located where it can best enhance the rigidity of the beam, and the damping patch can, for example, be located where it can best absorb vibrational energy to minimize vibrational amplitude. Because the system depicted in FIG. 5C includes the provided vibration reduction sheet, it demonstrates the synergistic effects of a damping patch and a stiffening patch applied at different locations or extents.

The second basic classification of structure can be categorized as fixed-fixed, or simply supported, beams or plates. Fixed-fixed structures are supported at multiple ends, at multiple boundaries, or all along their boundaries. In each case, a free portion remains in the center of the structure. As a result, the maximum deflection typically occurs at this central portion. To reduce the deflection, one or more stiffeners can be placed at the center of the structure. This placement can reduce the overall deflection in the structure, however such stiffening can also create new locations which exhibit higher deflections slightly away from the central region where the stiffener is placed. In these cases, the hybrid vibration reduction sheet allows damping treatments to be simultaneously applied at these new locations of higher deflection. Hence, the damping treatment location can be different than the stiffener location.

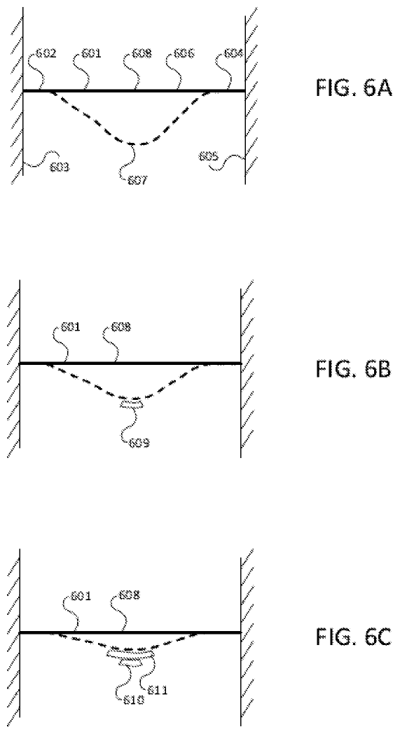

FIG. 6A illustrates a fixed-fixed beam 601 having a first fixed end 602 that is connected to a first support 603, and a second fixed end 604 that is connected to a second support 605. The fixed-fixed beam has a neutral form 606, and a vibrating form 607 that represents one of the forms of the beam as it vibrates. In some embodiments, and as is shown in FIG. 6A, the neutral form of the fixed-fixed beam is linear or substantially linear. Alternatively, the fixed-fixed beam can have a different form that comprises one or more curves or angles. Because the fixed ends of the fixed-fixed beam are connected to the supports, the central portion 608 of the beam typically exhibits the greatest displacement between the neutral form and the vibrating form as the beam vibrates. The system depicted in FIG. 6A does not include the provided vibration reduction sheet, and as a results does not demonstrate the synergistic effects of a damping patch and a stiffening patch applied at different locations or extents.

FIG. 6B illustrates the fixed-fixed beam 601 of FIG. 6A, to which a stiffening patch 609 has been added using conventional methods and materials. In some embodiments, and as shown in FIG. 6B, the stiffening patch is attached to the beam at a location that is proximate to the central portion 608 of the beam. The stiffening patch can comprise a material that is generally stiffer than the material of the beam. In this manner, the stiffening patch can comprise a rigid structure that can contribute to altering noise produced from vibrations. The system depicted in FIG. 6B does not include the provided vibration reduction sheet, and as a results does not demonstrate the synergistic effects of a damping patch and a stiffening patch applied at different locations or extents.

FIG. 6C illustrates the fixed-fixed beam 601 of FIG. 6A, to which a provided vibration reduction sheet, such as sheet 400 of FIG. 4, has been added. The sheet is applied to the base structure beam such that the stiffening patch 610 and the damping patch 611 are both positioned proximate to the central portion 608 of the beam. Because the damping patch is larger than the stiffening patch, the damping patch extends beyond the newly stiffened area of the beam, and can act to dampen vibrations in regions of the beam between the central portion and the fixed ends. Thus, through the application of this single hybrid construction, the stiffening patch and the damping patch are each connected to the base structure at locations where they will independently be the most effective as discussed above. Because the system depicted in FIG. 6C includes the provided vibration reduction sheet, it demonstrates the synergistic effects of a damping patch and a stiffening patch applied at different locations or extents.

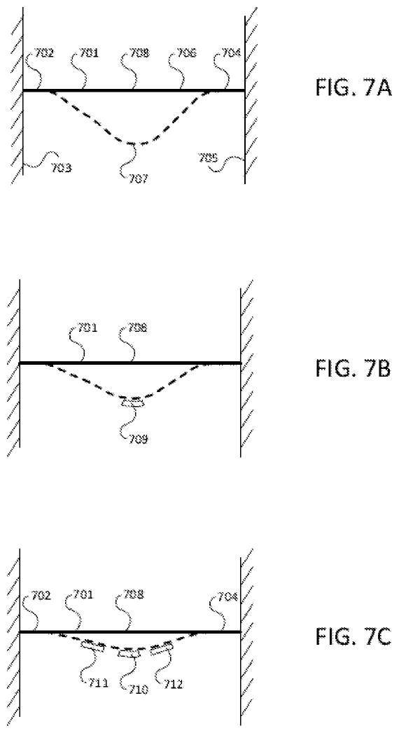

FIG. 7A illustrates a fixed-fixed beam 701 having a first fixed end 702 that is connected to a first support 703, and a second fixed end 704 that is connected to a second support 705. The fixed-fixed beam has a neutral form 706, and a vibrating form 707 that represents one of the forms of the beam as it vibrates. In some embodiments, and as is shown in FIG. 7A, the neutral form of the fixed-fixed beam is linear or substantially linear. Alternatively, the fixed-fixed beam can have a different form that comprises one or more curves or angles. Because the fixed ends of the fixed-fixed beam are connected to the supports, the central portion 708 of the beam typically exhibits the greatest displacement between the neutral form and the vibrating form as the beam vibrates. The system depicted in FIG. 7A does not include the provided vibration reduction sheet, and as a results does not demonstrate the synergistic effects of a damping patch and a stiffening patch applied at different locations or extents.

FIG. 7B illustrates the fixed-fixed beam 701 of FIG. 7A, to which a stiffening patch 709 has been added using conventional methods and materials. In some embodiments, and as shown in FIG. 7B, the stiffening patch is attached to the beam at a location that is proximate to the central portion 708 of the beam. The stiffening patch can comprise a material that is generally stiffer than the material of the beam. In this manner, the stiffening patch can comprise a rigid structure that can contribute to altering noise produced from vibrations. The system depicted in FIG. 7B does not include the provided vibration reduction sheet, and as a results does not demonstrate the synergistic effects of a damping patch and a stiffening patch applied at different locations or extents.

FIG. 7C illustrates the fixed-fixed beam 701 of FIG. 7A, to which a provided vibration reduction sheet, such as a sheet analogous to sheet 100 of FIG. 1 but having two damping patches, has been added. The sheet is applied to the base structure beam such that the stiffening patch 710 is positioned proximate to the central portion 708 of the beam. A first damping patch 711 is positioned closer to the first fixed end 702 than the stiffening patch is. A second damping patch 711 is positioned closer to the second fixed end 704 than the stiffening patch is. The first damping patch and the second damping patch do not contact the stiffening patch. Because the damping patches are not collocated with the stiffening patch, the damping patches can act to dampen vibrations in regions of the beam between the central portion and the fixed ends. Thus, through the application of this single hybrid construction, the stiffening patch and the damping patches are each connected to the base structure at locations where they will independently be the most effective as discussed above. Because the system depicted in FIG. 7C includes the provided vibration reduction sheet, it demonstrates the synergistic effects of a damping patch and a stiffening patch applied at different locations or extents.

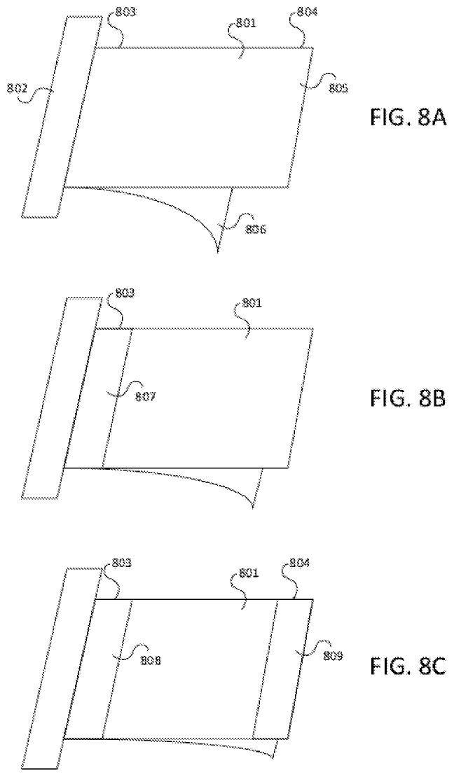

FIG. 8A illustrates a cantilever plate 801 that is connected to a support 802. The cantilever plate has a fixed end 803 that is the end of the plate that is connected to the support, and a free end 804 that is opposite the fixed end. The cantilever plate has a neutral form 805, and a vibrating form 806 that represents one of the forms of the plate as it vibrates. In some embodiments, and as is shown in FIG. 8A, the neutral form of the cantilever plate is planar or substantially planar. Alternatively, the cantilever plate can have a different form that comprises one or more curves or angles. Because the fixed end of the cantilever plate is connected to the support, the free end of the plate typically exhibits the greatest displacement between the neutral form and the vibrating form as the plate vibrates. The system depicted in FIG. 8A does not include the provided vibration reduction sheet, and as a results does not demonstrate the synergistic effects of a damping patch and a stiffening patch applied at different locations or extents.

FIG. 8B illustrates the cantilever plate 801 of FIG. 8A, to which a stiffening patch 807 has been added using conventional methods and materials. In some embodiments, and as shown in FIG. 8B, the stiffening patch is attached to the plate at a location that is proximate to the fixed end 803 of the plate. The stiffening patch can comprise a material that is generally stiffer than the material of the plate. In this manner, the stiffening patch can comprise a rigid structure that can contribute to altering noise produced from vibrations. The system depicted in FIG. 8B does not include the provided vibration reduction sheet, and as a results does not demonstrate the synergistic effects of a damping patch and a stiffening patch applied at different locations or extents.

FIG. 8C illustrates the cantilever plate 801 of FIG. 8A, to which a provided vibration reduction sheet, such as sheet 100 of FIG. 1, has been added. The sheet is applied to the base structure plate such that the stiffening patch 808 is closer to the fixed end 803 of the plate, and the damping patch 809 is closer to the free end 804. Through the application of this single hybrid construction, the stiffening patch and the damping patch are each connected to the base structure at locations where they will independently be the most effective as discussed above. The stiffening patch can, for example, be located where it can best enhance the rigidity of the plate, and the damping patch can, for example, be located where it can best absorb vibrational energy to minimize vibrational amplitude. Because the system depicted in FIG. 8C includes the provided vibration reduction sheet, it demonstrates the synergistic effects of a damping patch and a stiffening patch applied at different locations or extents.

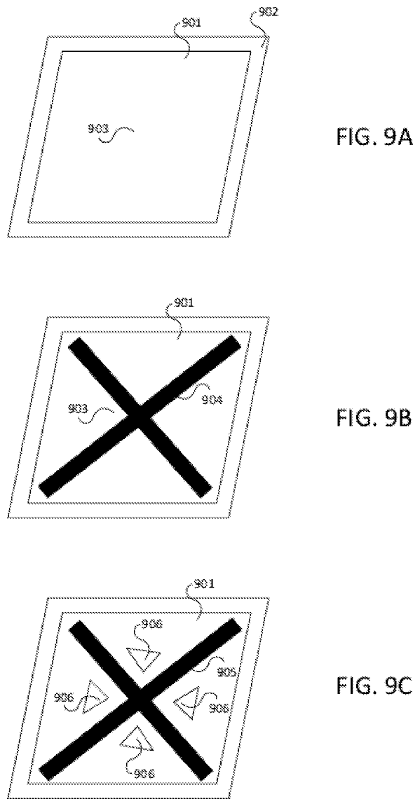

FIG. 9A illustrates a fixed-fixed-fixed-fixed plate 901 having a perimeter that is connected to a support 902. In some embodiments, and as is shown in FIG. 9A, the neutral form of the fixed-fixed-fixed-fixed plate is planar or substantially planar. Alternatively, the fixed-fixed plate can have a different form that comprises one or more curves or angles. Because the perimeter of the fixed-fixed-fixed-fixed plate is connected to the support, the central portion 903 of the plate typically exhibits the greatest displacement as the plate vibrates. The system depicted in FIG. 9A does not include the provided vibration reduction sheet, and as a results does not demonstrate the synergistic effects of a damping patch and a stiffening patch applied at different locations or extents.

FIG. 9B illustrates the fixed-fixed-fixed-fixed plate 901 of FIG. 9A, to which a stiffening patch 904 has been added using conventional methods and materials. In some embodiments, and as shown in FIG. 9B, the stiffening patch is attached to the plate at a location that is proximate to the central portion 903 of the beam. The stiffening patch can comprise a material that is generally stiffer than the material of the plate. In this manner, the stiffening patch can comprise a rigid structure that can contribute to altering noise produced from vibrations. The system depicted in FIG. 9B does not include the provided vibration reduction sheet, and as a results does not demonstrate the synergistic effects of a damping patch and a stiffening patch applied at different locations or extents.

FIG. 9C illustrates the fixed-fixed-fixed-fixed plate 901 of FIG. 9A, to which a provided vibration reduction sheet, such as a sheet analogous to sheet 100 of FIG. 1 but having four damping patches, has been added. The sheet is applied to the base structure plate such that the stiffening patch 905 is positioned proximate to the central portion of the plate. The stiffening patch is also located between all of the damping patches 906 along the surface of the plate. The damping patches do not contact the stiffening patch. Because the damping patches are not collocated with the stiffening patch, the damping patches can act to dampen vibrations in regions of the plate between the central portion and the fixed perimeter. Thus, through the application of this single hybrid construction, the stiffening patch and the damping patches are each connected to the base structure at locations where they will independently be the most effective as discussed above. Because the system depicted in FIG. 9C includes the provided vibration reduction sheet, it demonstrates the synergistic effects of a damping patch and a stiffening patch applied at different locations or extents.

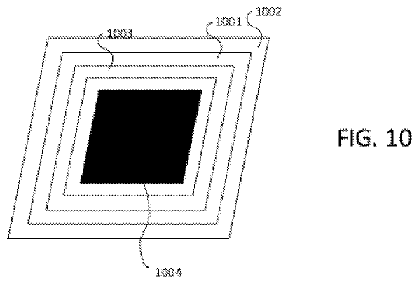

FIG. 10 illustrates a fixed-fixed-fixed-fixed plate 1001 having a perimeter that is connected to a support 1002. A provided vibration reduction sheet having a damping patch 1003 and a stiffening patch 1004 has been added to the plate. The damping patch does not contact the stiffening patch, and the damping patch surrounds the stiffening patch. Because the damping patch is not collocated with the stiffening patch, the damping patch can act to dampen vibrations in regions of the plate between the central portion and the fixed perimeter. Thus, through the application of this single hybrid construction, the stiffening patch and the damping patches are each mechanically connected to the base structure at locations where they will independently be the most effective as discussed above.

The present invention also relates to vehicles, appliances, or electronic devices that comprise one or more of any of the provided vibration reduction sheets as described above. In some embodiments, a vehicle comprises the vibration reduction sheet. In some embodiments, the vehicle is an automobile.

The following embodiments are contemplated. All combinations of features and embodiment are contemplated.

Embodiment 1: A vibration reduction sheet comprising: a damping patch having a Young's modulus; a stiffening patch having a Young's modulus, wherein the ratio of the stiffening patch Young's modulus to the damping patch Young's modulus is greater than or equal to 100; and a substrate having a substrate face in contact with the damping patch and the stiffening patch, wherein the damping patch and the stiffening patch are not in contact with one another

Embodiment 2: An embodiment of embodiment 1, wherein the ratio of the stiffening Young's modulus to the damping Young's modulus is greater than or equal to 10,000.

Embodiment 3: An embodiment of embodiment 1 or 2, further comprising: an adhesive layer connected to an adhesive face of the substrate, wherein the adhesive face is opposite the substrate face; and a liner layer connected to the adhesive layer opposite the substrate.

Embodiment 4: An embodiment of any of the embodiments of embodiment 1-3, wherein the damping patch substantially surrounds the stiffening patch.

Embodiment 5: An embodiment of any of the embodiments of embodiment 1-4, wherein the damping patch comprises one or more of an adhesive, a thermoplastic polyurethane, foam, metal, composite, or a rubber.

Embodiment 6: An embodiment of any of the embodiments of embodiment 1-5, wherein the damping patch comprises one or more layers of a damping material, and one or more layers of a stiffening material, wherein a majority of the thickness of the damping patch consists of the one or more layers of the damping material.

Embodiment 7: An embodiment of any of the embodiments of embodiment 1-6, wherein the stiffening patch comprises a metal, a carbon fiber reinforced plastic, a glass fiber reinforced plastic, or a combination thereof.

Embodiment 8: An embodiment of any of the embodiments of embodiment 1-7, wherein the stiffening patch comprises one or more layers of a stiffening material, and one or more layers of a damping material, wherein a majority of the thickness of the stiffening patch consists of the one or more layers of the stiffening material.

Embodiment 9: An embodiment of any of the embodiments of embodiment 1-8, wherein the damping patch is a first damping patch, and wherein the vibration reduction sheet further comprises: a second damping patch in contact with the substrate face, wherein the second damping patch is not in contact with the stiffening patch, and wherein the stiffening patch is located between the first and second damping patches along the substrate face.

Embodiment 10: A vibration reduction sheet comprising: a damping patch having a Young's modulus; and a stiffening patch having a Young's modulus, wherein the ratio of the stiffening Young's modulus to the damping Young's modulus is greater than or equal to 100, wherein the damping patch and the stiffening patch are in contact with one another, and wherein the damping patch and the stiffening patch are not coextensive with one another.

Embodiment 11: An embodiment of embodiment 10, wherein the ratio of the stiffening Young's modulus to the damping Young's modulus is greater than or equal to 10,000.

Embodiment 12: An embodiment of embodiment 10 or 11, further comprising: a substrate in contact with the damping patch opposite the stiffening patch, or in contact with the stiffening patch opposite the damping patch; an adhesive layer connected to the substrate opposite the damping patch and stiffening patch; and a liner layer connected to the adhesive layer opposite the substrate.

Embodiment 13: An embodiment of any of the embodiments of embodiment 10-12, wherein the damping patch comprises one or more of an adhesive, a thermoplastic polyurethane, foam, metal, composite, or a rubber.

Embodiment 14: An embodiment of any of the embodiments of embodiment 10-13, wherein the damping patch comprises one or more layers of a damping material, and one or more layers of a stiffening material, wherein a majority of the thickness of the damping patch consists of the one or more layers of the damping material.

Embodiment 15: An embodiment of any of the embodiments of embodiment 10-14, wherein the stiffening member comprises a metal, a carbon fiber reinforced plastic, a glass fiber reinforced plastic, or a combination thereof.

Embodiment 16: An embodiment of any of the embodiments of embodiment 10-15, wherein the stiffening member comprises one or more layers of a stiffening material, and one or more layers of a damping material, wherein a majority of the thickness of the stiffening patch consists of the one or more layers of the stiffening material.

Embodiment 17: A method of reducing the vibration of a base structure, the method comprising: providing a base structure that is subject to vibration; and connecting the vibration reduction sheet of any of the embodiments of embodiment 1-8 to the base structure, thereby reducing the vibration of the base structure.

Embodiment 18: An embodiment of embodiment 17, wherein the base structure comprises a cantilever having a fixed end connected to a support, and a free end opposite the fixed end.

Embodiment 19: An embodiment of embodiment 18, wherein the stiffening patch is disposed closer to the fixed end than the damping patch is.

Embodiment 20: An embodiment of embodiment 17, wherein the base structure comprises a beam or plate having a first fixed end connected to a first support, a second fixed end connected to a second support.

Embodiment 21: Am embodiment of embodiment 20, wherein the damping patch comprises a first damping patch, and wherein the vibration reduction sheet further comprises: a second damping patch in connection with the base structure, wherein the first damping patch is disposed closer to the first fixed end than the stiffening patch is, and wherein the second damping patch is disposed closer to the second fixed end than the stiffening patch is.

Embodiment 22: An embodiment of embodiment 17, wherein the base structure comprises a plate having a plate perimeter, wherein a majority of the plate perimeter is connected to one or more supports.

Embodiment 23: An embodiment of embodiment 22, wherein substantially all of the plate perimeter is connected to the one or more supports.

Embodiment 24: An embodiment of embodiment 22 or 23, wherein the damping patch comprises a first damping patch, and wherein the vibration reduction sheet further comprises: a second damping patch in connection with the base structure, wherein the stiffening patch is located between the first and second damping patch along the substrate.

Embodiment 25: An embodiment of any of the embodiments of embodiment 17-24, wherein the base structure comprises a metal or a polymer.

Embodiment 26: An embodiment of embodiment 25, wherein the base structure comprises aluminum or steel.

Embodiment 27: An embodiment of any of the embodiments of embodiment 17-26, wherein the base structure is a component of a vehicle.

Embodiment 28: An embodiment of embodiment 27, wherein the base structure is a component of an automobile.

Embodiment 29: A method of reducing the vibration of a base structure, the method comprising: providing a base structure that is subject to vibration; and connecting the vibration reduction sheet of any embodiment of embodiments 10-16 to the base structure, thereby reducing the vibration of the base structure.

Embodiment 30: An embodiment of embodiment 29, wherein the base structure comprises a cantilever having a fixed end connected to a support, and a free end opposite the fixed end.

Embodiment 31: An embodiment of embodiment 29, wherein the base structure comprises a beam or plate having a first fixed end connected to a first support, a second fixed end connected to a second support.

Embodiment 32: An embodiment of embodiment 29, wherein the base structure comprises a plate having a plate perimeter, wherein a majority of the plate perimeter is connected to one or more supports.

Embodiment 33: An embodiment of embodiment 32, wherein substantially all of the plate perimeter is connected to the one or more supports.

Embodiment 34: An embodiment of any of the embodiments of embodiment 29-33, wherein the base structure comprises a metal or a polymer.

Embodiment 35: An embodiment of embodiment 34, wherein the base structure comprises aluminum or steel.

Embodiment 36: An embodiment of any of the embodiments of embodiment 29-35, wherein the base structure is a component of a vehicle.

Embodiment 37: An embodiment of embodiment 36, wherein the base structure is a component of an automobile.

Embodiment 38: A vehicle comprising a vibration reduction sheet of an embodiment of any embodiment of embodiments 1-16.

Embodiment 39: An embodiment of embodiment 38, wherein the vehicle is an automobile

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

1. A vibration reduction sheet comprising:
a damping patch having a Young's modulus;
a stiffening patch having a Young's modulus, wherein the ratio of the stiffening patch Young's modulus to the damping patch Young's modulus is greater than or equal to 100; and
a substrate having a substrate face in contact with the damping patch and the stiffening patch, wherein the damping patch and the stiffening patch are not in contact with one another.

2. The vibration reduction sheet of claim 1, wherein the ratio of the stiffening Young's modulus to the damping Young's modulus is greater than or equal to 10,000.

3. The vibration reduction sheet of claim 1, further comprising:
an adhesive layer connected to an adhesive face of the substrate, wherein the adhesive face is opposite the substrate face; and
a liner layer connected to the adhesive layer opposite the substrate.

4. The vibration reduction sheet of claim 1, wherein the damping patch substantially surrounds the stiffening patch.

5. The vibration reduction sheet of claim 1, wherein the damping patch comprises one or more of an adhesive, a thermoplastic polyurethane, foam, metal, composite, or a rubber.

6. The vibration reduction sheet of claim 1, wherein the damping patch comprises one or more layers of a damping material, and one or more layers of a stiffening material, wherein a majority of the thickness of the damping patch consists of the one or more layers of the damping material.

7. The vibration reduction sheet of claim 1, wherein the stiffening patch comprises a metal, a carbon fiber reinforced plastic, a glass fiber reinforced plastic, or a combination thereof.

8. The vibration reduction sheet of claim 1, wherein the stiffening patch comprises one or more layers of a stiffening material, and one or more layers of a damping material, wherein a majority of the thickness of the stiffening patch consists of the one or more layers of the stiffening material.

9. The vibration reduction sheet of claim 1, wherein the damping patch comprises a first damping patch, and wherein the vibration reduction sheet further comprises:
a second damping patch in contact with the substrate face, wherein the second damping patch is not in contact with the stiffening patch, and wherein the stiffening patch is located between the first and second damping patches along the substrate face.

10. A vibration reduction sheet comprising:
a damping patch having a Young's modulus; and
a stiffening patch having a Young's modulus,
wherein the ratio of the stiffening Young's modulus to the damping Young's modulus is greater than or equal to 100;
wherein the damping patch and the stiffening patch are in contact with one another; and
wherein the damping patch and the stiffening patch are not coextensive with one another.

11. The vibration reduction sheet of claim 10, wherein the ratio of the stiffening Young's modulus to the damping Young's modulus is greater than or equal to 10,000.

12. The vibration reduction sheet of claim 10, further comprising:
a substrate in contact with the damping patch opposite the stiffening patch, or in contact with the stiffening patch opposite the damping patch;
an adhesive layer connected to the substrate opposite the damping patch and stiffening patch; and
a liner layer connected to the adhesive layer opposite the substrate.

13. The vibration reduction sheet of claim 10, wherein the damping patch comprises one or more of an adhesive, a thermoplastic polyurethane, foam, metal, composite, or a rubber.

14. The vibration reduction sheet of claim 10, wherein the damping patch comprises one or more layers of a damping material, and one or more layers of a stiffening material, wherein a majority of the thickness of the damping patch consists of the one or more layers of the damping material.

15. The vibration reduction sheet of claim 10, wherein the stiffening member comprises a metal, a carbon fiber reinforced plastic, a glass fiber reinforced plastic, or a combination thereof.

16. The vibration reduction sheet of claim 10, wherein the stiffening member comprises one or more layers of a stiffening material, and one or more layers of a damping material, wherein a majority of the thickness of the stiffening patch consists of the one or more layers of the stiffening material.

17. A method of reducing the vibration of a base structure, the method comprising:
providing a base structure that is subject to vibration; and
connecting the vibration reduction sheet of claim 1 to the base structure, thereby reducing the vibration of the base structure.

18. The method of claim 17, wherein the base structure comprises a cantilever having a fixed end connected to a support, and a free end opposite the fixed end.

19. The method of claim 18, wherein the stiffening patch is disposed closer to the fixed end than the damping patch is.

20. The method of claim 17, wherein the base structure comprises a beam or plate having a first fixed end connected to a first support, a second fixed end connected to a second support.

21. The method of claim 20, wherein the damping patch comprises a first damping patch, and wherein the vibration reduction sheet further comprises:
a second damping patch in connection with the base structure, wherein the first damping patch is disposed closer to the first fixed end than the stiffening patch is, and wherein the second damping patch is disposed closer to the second fixed end than the stiffening patch is.

22. The method of claim 17, wherein the base structure comprises a plate having a plate perimeter, wherein a majority of the plate perimeter is connected to one or more supports.

23. The method of claim 22, wherein substantially all of the plate perimeter is connected to the one or more supports.

24. The method of claim 22, wherein the damping patch comprises a first damping patch, and wherein the vibration reduction sheet further comprises:
a second damping patch in connection with the base structure, wherein the stiffening patch is located between the first and second damping patch along the substrate.

25. The method of claim 17, wherein the base structure comprises a metal or a polymer.

26. The method of claim 25, wherein the base structure comprises aluminum or steel.

27. The method of claim 17, wherein the base structure is a component of a vehicle.

28. The method of claim 27, wherein the base structure is a component of an automobile.

29. A method of reducing the vibration of a base structure, the method comprising:
providing a base structure that is subject to vibration; and
connecting the vibration reduction sheet of claim 10 to the base structure, thereby reducing the vibration of the base structure.

30. The method of claim 29, wherein the base structure comprises a cantilever having a fixed end connected to a support, and a free end opposite the fixed end.

31. The method of claim 29, wherein the base structure comprises a beam or plate having a first fixed end connected to a first support, a second fixed end connected to a second support.

32. The method of claim 29, wherein the base structure comprises a plate having a plate perimeter, wherein a majority of the plate perimeter is connected to one or more supports.

33. The method of claim 32, wherein substantially all of the plate perimeter is connected to the one or more supports.

34. The method of claim 29, wherein the base structure comprises a metal or a polymer.

35. The method of claim 34, wherein the base structure comprises aluminum or steel.

36. The method of claim 29, wherein the base structure is a component of a vehicle.

37. The method of claim 36, wherein the base structure is a component of an automobile.

38. A vehicle comprising a vibration reduction sheet of claim 1.

39. The vehicle of claim 38, wherein the vehicle is an automobile.
